(19) United States
(12) Patent Application Publication
(10) Pub. No.: US 2008/0318091 A1
(43) Pub. Date: Dec. 25, 2008

(54) METHOD AND SYSTEM OF OPERATING A HIGH-TEMPERATURE FUEL CELL

(76) Inventors: Mihails Kusnezoff, Dresden (DE); Wieland Beckert, Dresden (DE); Ivanka Milcheva, Bayreuth (DE); Michael Stelter, Rohrsdorf (DE); Ulf Waeschke, Dresden (DE)

Correspondence Address: GAUTHIER & CONNORS, LLP, 225 FRANKLIN STREET, SUITE 2300, BOSTON, MA, 02110, US

(21) Appl. No.: 12/174,822

(22) Filed: Jul. 17, 2008

Related U.S. Application Data
(63) Continuation of application No. PCT/DE2007/000120, filed on Jan. 17, 2007.

(30) Foreign Application Priority Data
Jan. 20, 2006 (DE) 102006003740.5

(51) Int. Cl. H01M 8/00; H01M 8/04; H01M 8/18

(52) U.S. Cl. 429/13; 429/26; 429/20

(57) ABSTRACT

The invention relates to a method and to a system of operating a high-temperature fuel cell. At least one fuel cell, a reformer, an afterburner and a heat exchanger are present in the system. The total efficiency should be increased with the invention in accordance with the object set. In accordance with the invention, for this purpose, fresh air supplied to the fuel cell(s) at the cathode side is preheated in multiple stages by heat from the afterburning and from the heated air dissipated from the fuel cell(s) at the cathode side by means of a high-temperature heat exchanger.

### PRIORITY INFORMATION

The present invention is a continuation of PCT Application No. PCT/DE2007/000120, filed on Jan. 17, 2007, that claims priority to German Application No. 102006003740.5, filed on Jan. 20, 2006, both of which are incorporated herein by reference in their entireties.

### BACKGROUND OF THE INVENTION

The invention relates to a method and to a system of operating a high-temperature fuel cell having a fuel containing hydrocarbon compounds such as in particular biogas and/or natural gas with a high total efficiency. In this connection, a gas treatment unit, a reformer, an individual fuel cell or a plurality of fuel cells in the form of a fuel cell stack (SOFC module) and an afterburner can be present.

High-temperature fuel cells (SOFCs) have already been put into operation as demonstrator systems with an electrical power of 100 kW (Siemens-Westinghouse) and 1 kW (Sulzer-Hexis). The electrical efficiency of the high-temperature fuel cell is at >50% as a rule. The total efficiency can exceed 85% with decentralized systems when the heat utilization is taken into account.

The fuel cell systems in particular have less electrical efficiency than the fuel cells themselves at low electrical powers ≦2 kW based on the energy consumption by compressors and other peripherals. For this reason, there is a need for the ideal configuration of such systems for efficient operation. In this respect, the electrical consumers in the system should be reduced to a large extent and the heat arising in the system should be utilized effectively.

It is thus known, for example, from DE 101 49 014 A1 to operate a fuel cell stack in combination with an afterburner and to preheat the waste heat of both technical elements for the preheating of fresh air which is supplied to the fuel cells at the cathode side. In this respect, fresh air flows along a chamber wall via which the heat exchange from the fuel cell stack and the afterburner can be achieved.

The exhaust air exiting the fuel cells at the cathode side is supplied directly to the afterburner.

However, the total efficiency cannot be increased to a sufficiently large degree with such a solution.

It is therefore the object of the invention to increase the total efficiency of high-temperature fuel cells.

This object is solved in accordance with the invention by a method having the features of claim 1 as well as by a system in accordance with claim 13. Advantageous aspects and further developments can be achieved using the features designated in the subordinate claims.

### SUMMARY OF THE INVENTION

In the invention, at least one high-temperature fuel-cell is present, preferably a plurality of high-temperature fuel cells stacked over one another, whose fuel inlet is connected to a reformer and whose exhaust gas outlet opens into an afterburner. The fresh air for the fuel cell(s) is preheated by heat from the afterburner in multiple stages by exhaust gas from the fuel cell(s), optionally additionally by heat from a heat insulation. In this respect, the heat of the exhaust gas of the afterburner can also be utilized.

Since the heat of the afterburner is not sufficient for the required air preheating at the high gas utilization in fuel cells (60%), (fresh air heated in this manner reaches a temperature of 500-600° C. instead of the required 750° C.), additional heat is supplied to the fresh air prior to the entry into the fuel cell(s) from the exhaust air of fuel cells via a further heat exchanger so that a multi-stage heating of the fresh air supplied at cathode side is carried out. This high-temperature heat exchanger has a temperature gradient of 300° C. (500-800° C.) and can be made as a compact assembly since the temperature level of the heat-exchanging media (fresh air and exhaust air) do not differ greatly from one another. Since it is an air/air heat exchanger, any small leaks only impair the operation of the system to a negligible extent if at all.

The reformer and afterburner should be designed such that they are capable of withstanding short-term (up to 5 h) temperature loads of up to 1,000° C. It can thereby be ensured that fuel cells can be preheated to the operating temperature by the complete combustion of the fuel containing hydrocarbon compounds in the reformer and afterburner with the residual gases from the prereformer as well as with the fresh air which is preheated by the afterburner.

The temperature control in the reformer and in the afterburner can take place by the control or feedback control of the supplied fresh-air volume flow.

The operating point of a catalytic reformer is defined by the spraying of the gas mixture formed from the fuel and moistened air and is controlled by a lambda sensor. The air supplied to the reformer can be moistened in a water tank by evaporation of water by means of exhaust air from the fuel cell(s) and can be introduced into the reformer via a metering valve.

The afterburning of the exhaust gas from the fuel cells(s) in the after burner can be carried out in a temperature-controlled manner. The temperature of the combustible exhaust gas should be lowered prior to the afterburning to avoid auto-ignition on the premixing with the air. This heat can additionally be utilized for the multi-stage heating of the fresh air supplied to the fuel cell(s).

The elements of the system which have an operating temperature of >600° C. should be arranged in a heat-insulated housing and heat radiation reflected from the inner housing wall can likewise preferably be used to increase the efficiency.

This relates to the elements of the fuel cell(s), the high-temperature heat exchanger, the afterburner and the reformer. The heat dissipation from fuel cell(s) (lower fresh air consumption) and the heat supply to the reformer (higher water vapor concentration, lower nitrogen concentration) can thereby be improved. These elements are insulated from other elements by heat insulation to minimize the heat losses of the system.

The remaining components such as a fuel cleaning, air moistening, control, etc. can be accommodated in a “cold” region (<200° C.).

Water present in the exhaust gas can be condensed at the gas outlet, returned in the system and optionally be used for the moistening of air supplied from the reformer.

To reduce the consumption of electrical energy of the system, valves should be operated pneumatically. The compressors for fresh air and fuel can likewise advantageously be driven with water vapor which arises from the water vaporization due to the hot exhaust gases of the system.

Fuel should be supplied to the fuel cell(s) at the anode side at a temperature of at least 600° C. and with a composition of 0 to 50 mol % nitrogen, 0 to 18 mol % of at least one hydrocarbon compound, 10 to 90 mol % hydrogen, 5 to 35 mol % carbon monoxide, 2.5 to 35 mol % water vapor and 0.5 to 50 mol % carbon dioxide. The respective composition depends on the fuel used.

In addition, exhaust air lines or exhaust gas lines can open into a chimney, which can likewise reduce the supplied energy requirement, in particular for the drive of compressors.

Systems can be provided by the invention which can achieve an electrical power in the range of 300 W to 20 kW and an electrical efficiency greater than 30%. The consumption of energy, in particular electrical energy, for the actual operation of a system can be reduced.

Waste heat losses can likewise be reduced.

A substantial advantage consists of the preheating of the fresh air via heat exchange likewise with air as the hot medium so that the safety can be increased and leak losses are not critical.

The supply of fresh water can be omitted with a closed water circuit.

A system in accordance with the invention can be operated without additional elements through a possible operating regime, which in particular applies to the start-up operation. A warming up to operating temperature with the afterburner, which should preferably be made as a porous burner, can thus take place.

The invention will be explained in more detail by way of example in the following.

There are shown:

### DETAILED DESCRIPTION OF THE ILLUSTRATED EMBODIMENTS

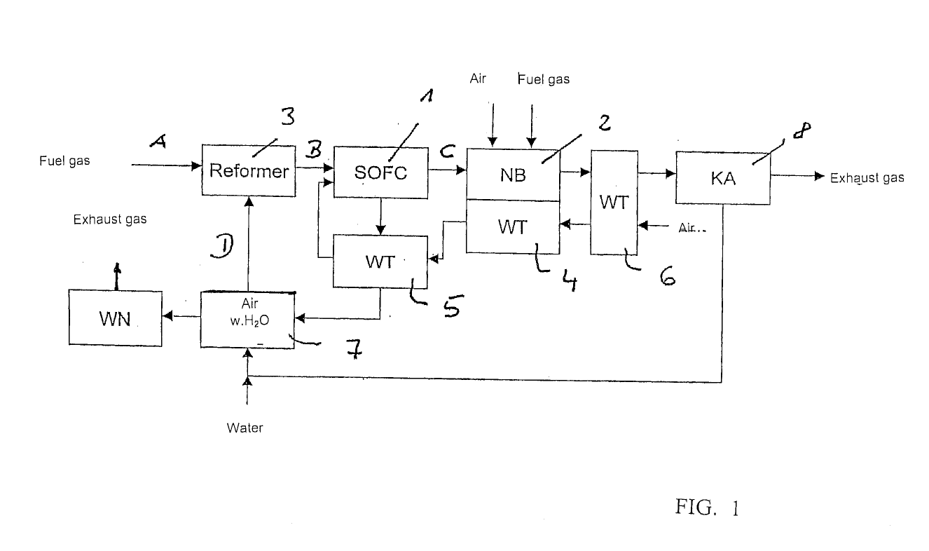

FIG. 1 a schematic design of an example of a system in accordance with the invention; and

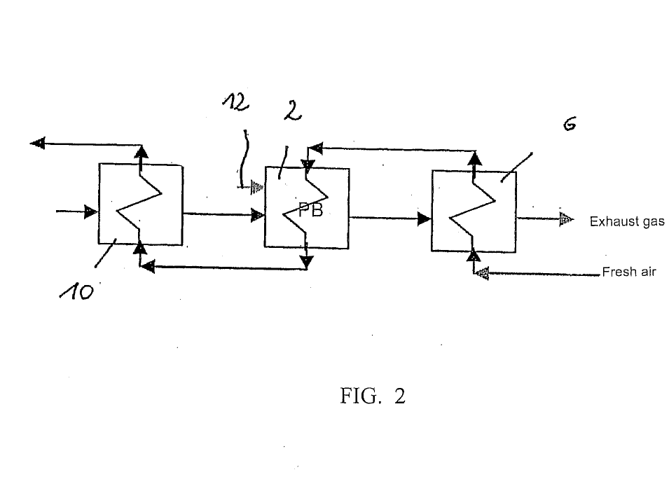

FIG. 2 an arrangement of a heat exchanger at an afterburner.

FIG. 1 thus shows a schematic design of an example of a system in accordance with the invention.

In this respect, fuel (biogenic gas, natural gas, coal gas, propane, butane, methanol and/or ethanol) is brought to a specific excess pressure using a compressor, not shown, and is subsequently purified and desulfurized in an assembled filter (not shown). If necessary, oxygen which can be present in the gas can also be eliminated. The fuel is mixed with moist air in an autothermal reformer 3. Reformat gas is generated under the influence of catalysts and is introduced into the fuel cells 1 forming a stack. The conversion of any hydrocarbons (CH4) still contained in the reformat gas into gas components (H2, CO) convertible by electrochemical oxidation takes place by internal reformation in fuel cells 1. The electrochemical reactions also take place there which result in the current generation. The DC current is fed into the mains (AC current 50 Hz, 230 V) via an inverter. The exhaust gas from the fuel cells 1 at the anode side is guided to an afterburner 2.

It should be illustrated by FIG. 2 how, in a first stage, the exhaust gas from the fuel cells 1 can be cooled by the counterflow fresh air, already preheated, in a heat exchanger 10 to a temperature which prevents auto-ignition on the mixture with intake air from the environment in front of the downstream porous burner 2.

The intake of the fresh air 12 for the porous burner 2 can take place independently of the intake of the fresh air for the fuel cells 1. The complete oxidation of the exhaust gas from the fuel cells 1 is carried out in the porous burner 2. The fresh air takes up some of the oxidation heat, whereby the porous burner 2 is cooled and is maintained at a constant temperature. The exhaust gas from the porous burner, as an afterburner 2, is cooled in the downstream heat exchanger 9 which is made as a counterflow heat exchanger. The residual cooling of the exhaust gas can be carried out in an external heat consumer (not shown). The water and the condensation heat are acquired in a condensate separator 8. Some of the condensed water is returned into the system as process water and is fed into an evaporator for the generation of water vapor via a circulating pump.

To minimize the electrical consumption of a fuel compressor, the fresh air can suck in some of the exhaust gases through a Venturi nozzle (not shown). Some of the exhaust gas flow is thereby branched off and mixed with the fresh air. The Venturi nozzle generates an underpressure on the fuel exhaust gas side from the fresh air flow and thus has an amplifying effect on the fuel flow through the fuel cells 1.

Fresh air from the environment is conveyed into the system through an air compressor (not shown) and is purified in a particle filter (not shown). Some of the afterburner gases can be mixed with this fresh air by means of a Venturi nozzle and can subsequently be heated in the afterburner 2. Since the heat supplied in this manner is not sufficient to heat the air to the temperature of at least 700° C., a further air heating takes place subsequently in the system with the help of a high-temperature heat exchanger 5, which can be made as a plate heat exchanger (recuperator), by the hot exhaust air from the fuel cells 1 led off at the cathode side. The fresh air heated in this manner is supplied from the high-temperature heat exchanger 5 to the fuel cells 1 at the cathode side where the oxygen contained therein participates in the electrochemical reactions. The residual heat of the exhaust air after the high-temperature heat exchanger 5 is partially utilized as a heat source for the evaporation; the remainder is available to further heat consumers WN. Some of the exhaust air cooled in the evaporator is mixed with some of the vapor generated from the returned process water and is available to the reformer 3 as moistened air.

Since a substantial amount of air is needed for the cooling of the fuel cells 1, the electrical power of the air compressor represents a substantial amount of the total electrical requirements of the system. These requirements can be reduced when the residual heat from the hot exhaust air can be used for the drive of compressors. This can take place via water vapor generation. The vapor generated can be used for the drive of the air compressor and/or fuel compressor. The air intake can be amplified by an additional air draft through a chimney.

As can be seen from FIGS. 1 and 2, in the invention, the fresh air can be heated in multiple stages before it is supplied to the fuel cells 1 at the cathode side. This can be achieved with the exhaust gas from the afterburner 2 in the heat exchanger 6, with a heat exchanger 4 integrated in the afterburner 2, received therein or connected to the afterburner, with a heat exchanger 10 (example in accordance with FIG. 2) and with the high-temperature heat exchanger 5.

Table 1 shows gas temperatures and gas compositions at characteristic points in a methane-operated system for natural gas.

| | Temperature | Mol % | Mol % | Mol % | Mol % | Mol % | Mol % | Mol % |
|---|---|---|---|---|---|---|---|---|
| Point | [° C.] | O2 | N2 | CH4 | H2 | H2O | CO | CO2 |
| A | 20 | 0 | 0 | 100 | 0 | 0 | 0 | 0 |
| B | 654 | 0 | 47 | 1 | 30 | 8 | 9 | 5 |
| C | 860 | 0 | 46 | 0:012 | 10 | 29 | 4 | 11 |
| D | 50 | 16.8 | 67 | 0 | 0 | 16 | 0 | 0.2 |

In this connection, point A is the inlet for fuel; point B is the outlet of the reformer 3 to the fuel cells 1; point C is the anode-side outlet for the fuel cells 1 for exhaust gas; and point D is the outlet of the heat exchanger 7 to the reformer 3.

What is claimed is:

1. A method of operating a high-temperature fuel cell having a fuel containing hydrocarbon compounds which is supplied via a reformer to at least one fuel cell; fresh air being moreover supplied to the fuel cell(s) at the cathode side and anode-side gas of the fuel cell(s) being subjected to an afterburning in an afterburner, wherein fresh air supplied to the fuel cell(s) at the cathode side is preheated in multiple stages with heat from the afterburning and with the heated air dissipated at the cathode side from the fuel cell(s).

2. A method in accordance with claim 1, wherein the fresh air flows into the fuel cell(s) through at least one region of the afterburner, which is made as a heat exchanger, and a further high-temperature heat exchanger. through which hot exhaust air dissipated from the fuel cell(s) at the cathode side is guided.

3. A method in accordance with claim 1, wherein fresh air is heated in two stages with exhaust gas from the afterburner and the heat of the afterburner.

4. A method in accordance with claim 1, wherein fresh air is additionally heated with exhaust gas exiting the fuel cell(s) at the anode side.

5. A method in accordance with claim 1, wherein heated exhaust air from the fuel cell (s) exiting the high-temperature heat escaping is supplied to a heat exchanger disposed before the reformer.

6. A method in accordance with claim 5, wherein air heated and moistened with the heat exchanger is supplied to the reformer.

7. A method in accordance with claim 1, wherein a temperature feedback control is carried out by regulation of the volume flow of the supplied fresh air.

8. A method in accordance with claim 1, wherein exhaust gas from the afterburner is supplied to a condensate separator (8) and some of the water separated therein, as process water, is supplied for the moistening of the heated air supplied to the reformer.

9. A method in accordance with claim 1, wherein the reformer, the fuel cell(s), the afterburner and the heat exchanger are together accommodated in a heat-insulated housing and are acted on by heat radiation reflected from the inner housing wall.

10. A method in accordance with claim 1, wherein natural gas, biogenic gas, propane, butane, methanol and/or ethanol are used as the fuel.

11. A method in accordance with claim 1, wherein a fuel is supplied to the fuel cell(s) at the anode side at a temperature of at least 600° C. and with a composition of 0 to 50 mol % nitrogen, 0 to 18 mol % of at least one hydrocarbon compound, 10 to 90 mol % hydrogen, 5 to 35 mol % carbon monoxide, 2.5 to 35 mol % water vapor and 0.5 to 50 mol % carbon dioxide.

12. A method in accordance with claim 1, wherein compressors for fresh air and/or fuel are driven by internally generated water vapor.

13. A system for the operation of a high-temperature fuel cell using a method in accordance with claim 1, wherein fresh air is guided to an afterburner for heating while utilizing waste heat and is subsequently supplied to a high-temperature heat exchanger, with a connection for hot exhaust air dissipated from the fuel cell(s) at the cathode side being present at the high-temperature heat exchanger; and
heated fresh air from the high-temperature heat exchanger being able to be supplied to the fuel cell(s) at the cathode side.

14. A system in accordance with claim 13, wherein hot exhaust air from the high-temperature heat exchanger can be supplied to a further heat exchanger connected to the reformer for the heating and moistening of fresh air supplied from the reformer via this heat exchanger.

15. A system in accordance with claim 13, wherein the reformer, the fuel cell(s), the afterburner and the heat exchangers are arranged within a heat-insulating housing.

16. A system in accordance with claim 15, wherein the inner wall of the housing is reflective for heat radiation.

17. A system in accordance with claim 13, wherein the afterburner is made as a porous burner.

18. A system in accordance with claim 13, wherein the reformer is made as a catalytic reformer.

19. A system in accordance with claim 13, wherein the control of valves takes place pneumatically.

20. A system in accordance with claim 13, wherein lines for exhaust air and exhaust gas open into a chimney.
